(19) United States
(12) Patent Application Publication
(10) Pub. No.: US 2018/0258977 A1
(43) Pub. Date: Sep. 13, 2018

(54) Fastener with Loop or Hook

(71) Applicant: Jordan Pool, Ukiah, CA (US)

(72) Inventor: Jordan Pool, Ukiah, CA (US)

(21) Appl. No.: 15/975,450

(22) Filed: May 9, 2018

Related U.S. Application Data
(63) Continuation of application No. 14/797,423, filed on Jul. 13, 2015.
Application No. 14/797,423 is a continuation-in-part of application No. 29/520,036, filed on Mar. 10, 2015, now Pat. No. D790329.
(60) Provisional application No. 62/089,872, filed on Dec. 10, 2014.

(51) Int. Cl. F16B 45/00

(52) U.S. Cl. CPC F16B 45/00; F16B 23/0007

(57) ABSTRACT

A fastener formed of an eyelet loop, forming a loop shaped section. The eyelet loop having a first hole at a first section, said first hole holding a threaded fastener therein, where the fastener has a fastener head that holds against an inside surface of the first hole, and an outside surface of the first hole adapted and sized for abutting against an attachment surface to which the eyelet loop will be fastened. The eyelet loop having a second hole on an opposite section of the loop from a location of the first hole. An axis extends between said first hole and said second hole, and said axis being perpendicular to the attachment surface, where said second hole is defined by inner surfaces that allow for clearance of a driving tool to be inserted on and along said axis and perpendicular to said attachment surface, and where the driving tool has a connection to the head of the fastener that rotates said fastener, and where said surfaces are sized to allow the tool to be inserted through the second hole along the axis to the first hole to rotate the fastener as the tool is rotated, and where the threaded fastener is also on the axis extending between the first hole and the second hole, where the head of the threaded fastener holds against the inside surface of the first hole and does not fall out of the first hole without unscrewing.

This is a continuation of Ser. No. 14/797,423, filed Jul. 13, 2015, which is a continuation in part of Ser. No. 29/520,036 filed Mar. 10, 2015; which itself claims the benefit of priority to the U.S. Provisional Patent application filed on Dec. 10, 2014, having application Ser. No. 62/089,872, the entire contents of each of which are herewith incorporated by reference.

### BACKGROUND

The field of inventions is threaded axial fasteners, such as screws or bolts, having loops, hooks or eyelets opposite the threaded end that is intended for insertion into objects, and more particularly those more specifically suitable for insertion with rotary driving tools, such as power tools.

Threaded fasteners and supports that end with an open loop, which is a hook, or a closed loop, such as eye bolts and the like, is usually inserted by hand into a pilot hole or threaded insert.

U.S. Pat. No. 5,252,016, issued to Schmid et al. on Oct. 12, 1993, describes such fasteners that can be inserted by power tool by placing the driver receptacle on the outside of the loop or hook, opposite the end of the threaded shank. However, this solution also makes it more difficult to align the fastener shank normal to the wall, which is co-axial with the pilot hole, to start insertion. This is most difficult with heavy, bulky or cumbersome power tools, especially in awkward orientation, which make it more likely for the user or tradesman to tilt the tool off axis. When the power tool is more distal from the shank tip, the torque lever arm increases to urge the shank to tilt prior to insertion. Accordingly, even such an improved fastener is best started by hand instead of using a power tool.

It would be an advantage to have such a loop or hook type fastener that can be both started and fully inserted with the same power tool.

It would be a further advantage if such fastener devices can be inserted with one hand frees, to provide greater worker safety and increase efficiency.

The above and other objects, effects, features, and advantages of the present invention will become more apparent from the following description of the embodiments thereof taken in conjunction with the accompanying drawings.

### SUMMARY

In the present invention, an embodiment describes a hooked fastener that is held in place and can be screwed in with a tool that extends through the hook, and without holding the screw or the hook.

### BRIEF DESCRIPTION OF THE DRAWINGS

The different figures show different embodiments.

FIG. 1A is a cross-sectional elevation of a first embodiment of the invention, whereas FIG. 1B is top plan view thereof and FIG. 1C is a rear elevation view thereof showing the fastener device as viewed from the outside of a receiving member.

FIG. 2A is a cross-sectional elevation of another embodiment of the invention, whereas FIG. 2B is top plan view thereof and FIG. 2C is a rear elevation view thereof showing the fastener device as viewed from the outside of a receiving member.

FIG. 3A is a cross-sectional elevation of another embodiment of the invention, whereas FIG. 3B is top plan view thereof and FIG. 3C is a rear elevation view thereof showing the fastener device as viewed from the outside of a receiving member.

FIG. 4A is a cross-sectional elevation of another embodiment of the invention, whereas FIG. 4B is top plan view thereof and FIG. 4C is a rear elevation view thereof showing the fastener device as viewed from the outside of a receiving member.

FIG. 5A is a cross-sectional elevation of another embodiment of the invention, whereas FIG. 5B is top plan view thereof and FIG. 5C is a rear elevation view thereof showing the fastener device as viewed from the outside of a receiving member.

FIG. 6A is a cross-sectional elevation of another embodiment of the invention, whereas FIG. 6B is top plan view thereof and FIG. 6C is a rear elevation view thereof showing the fastener device as viewed from the outside of a receiving member.

FIG. 7A is a cross-sectional elevation of another embodiment of the invention, whereas FIG. 7B is top plan view thereof and FIG. 7C is a rear elevation view thereof showing the fastener device as viewed from the outside of a receiving member.

FIG. 8A is a cross-sectional elevation of another embodiment of the invention, whereas FIG. 8B is top plan view thereof and FIG. 8C is a rear elevation view thereof showing the fastener device as viewed from the outside of a receiving member.

FIG. 9A is a cross-sectional elevation of another embodiment of the invention, whereas FIG. 9B is top plan view thereof and FIG. 9C is a rear elevation view thereof showing the fastener device as viewed from the outside of a receiving member, whereas FIG. 9D is an expanded view of the circled portion of FIG. 9A.

FIG. 10 is an exterior elevation view of a driver tool about to insert the fastener of the FIG. 1A-C into a wall or other supporting member.

FIG. 11 is a perspective view of another embodiment of the invention in which the fastener is fabricated from one or more elongated members with circular cross-sections that are attached to a screw.

FIG. 12 is a perspective view of another embodiment of the invention in which the fastener is a hook fabricated from one or more elongated members with circular cross-sections that receives a screw in the eyelet portion thereof.

FIG. 13A is a perspective view of another embodiment of the invention in which the fastener is a hook and FIG. 13B is a cross-sectional elevation view thereof and FIG. 13C is a lower side view that includes the section shown at line C-C in FIG. 13B.

FIG. 14 is a cross-sectional elevation view of another embodiment of the invention in which an adhesive initially hold the screw in the eyelet portion.

### DETAILED DESCRIPTION

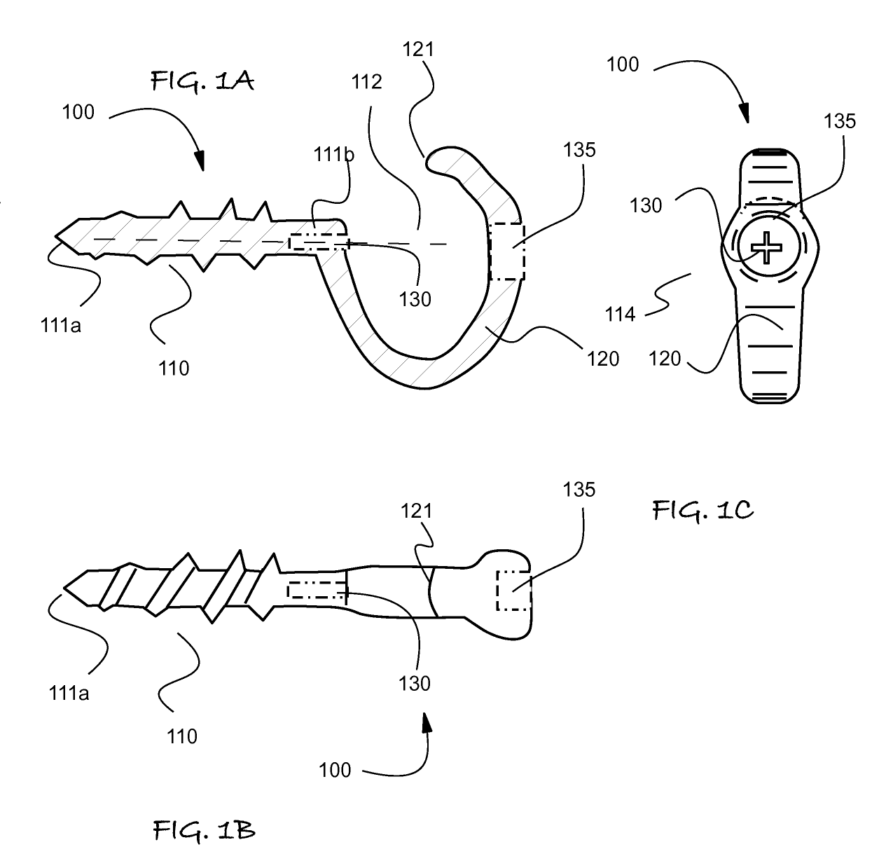

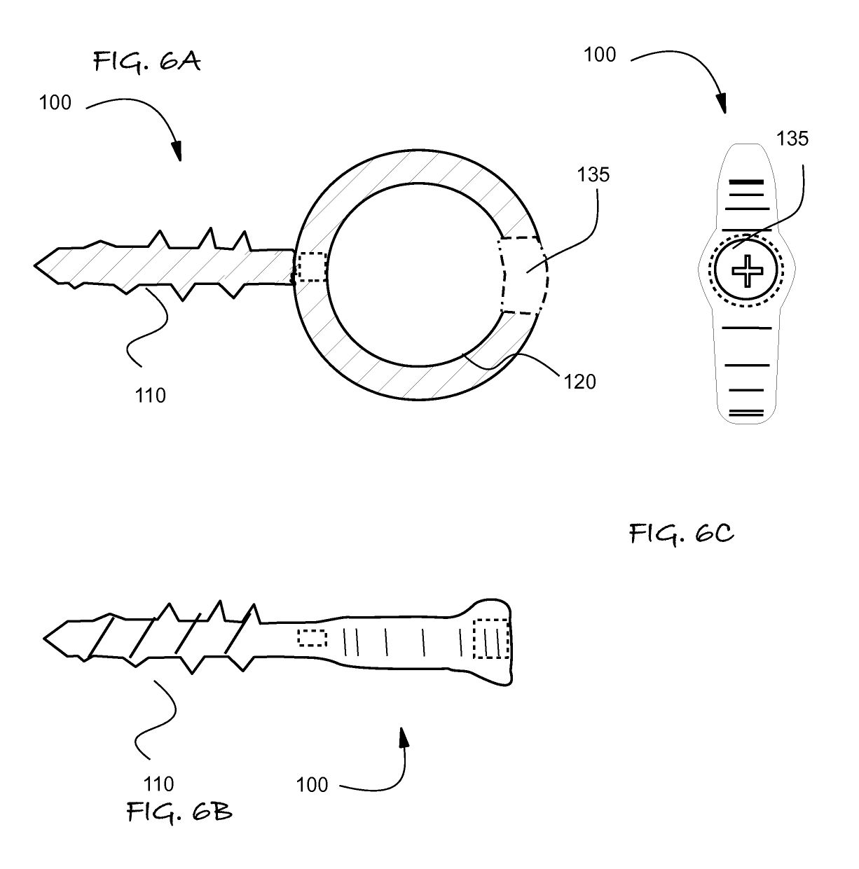

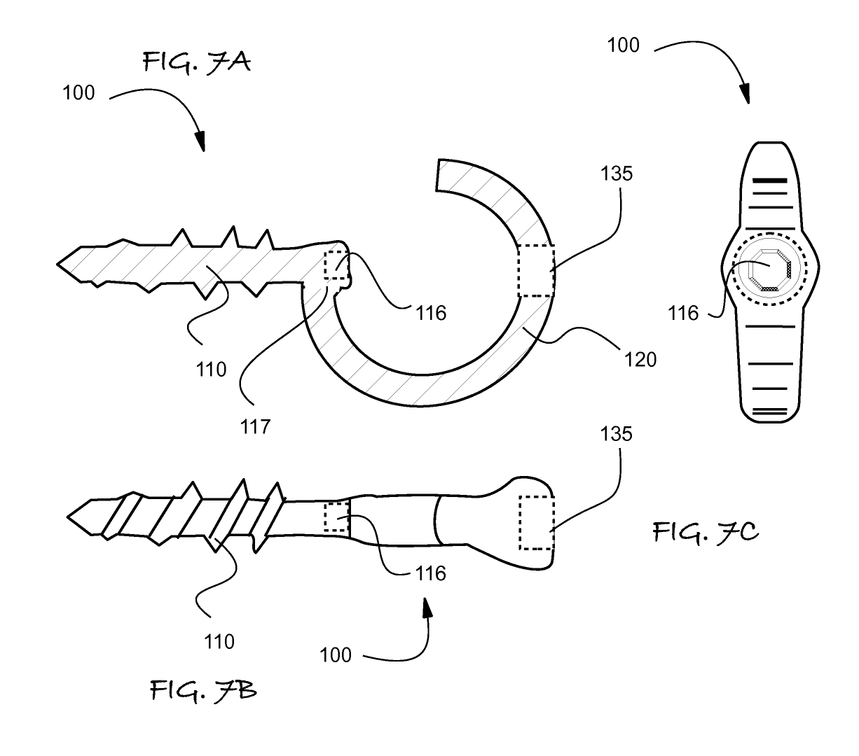

Referring to FIGS. 1A through 14, wherein like reference numerals refer to like components in the various views, there is illustrated therein a new and improved threaded fastener with loop or hook, generally denominated 100 herein.

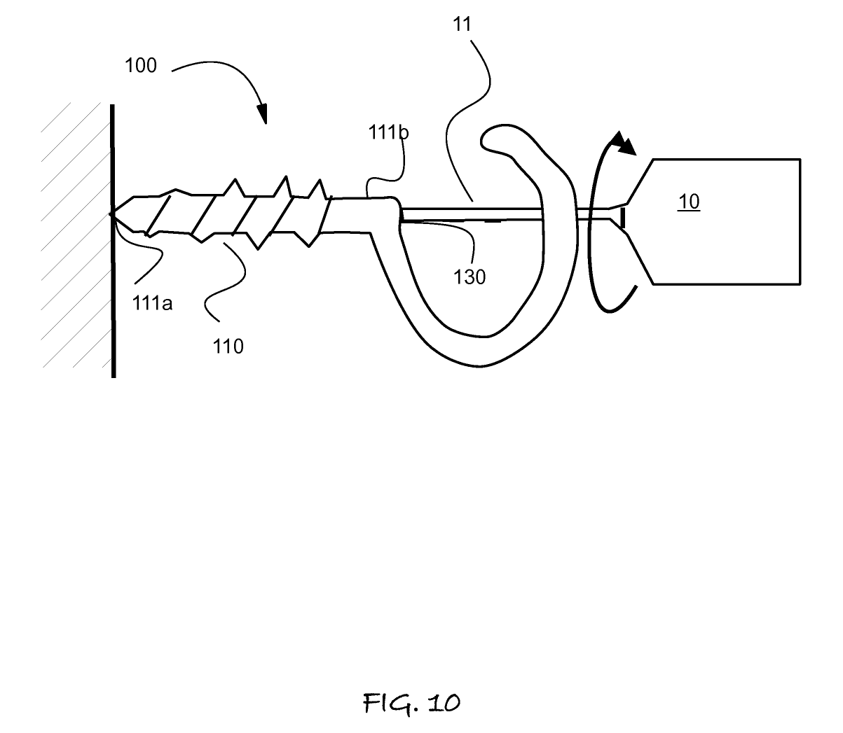

In accordance with the present invention the threaded fastener with loop or hook 100 comprises a threaded shank 110 configured for insertion into a work piece at the distal end 111a, with a hook or loop 120 attached toward or at the proximal end 111b. The threaded hook or eye loop 100 has a tool receptacle 130 at the end 111b of the threaded shank 110 with the hook or loop configured for rotary insertion with a power tool or hand tool that directly rotates the threaded shaft or shank 110. The hook or loop 120 is configured so that the tool receiving member 130 at the proximal end can 111b can be accessed by the working end 11 of a linear drive tool 10, which is connected outside the loop 120. The loop 120 forms a hook when it is open in the top or distal end 121, in which it does not reconnect or couple at the opposing end to the shank 110. FIG. 10 illustrates one embodiment of the fastener 100, from FIG. 1A-C, being inserted with the driving tool 10 in which the working end 11 thereof engage the tool receiving member 130 for rotating the fastener 100 to advance end 111a into the work piece to the left.

The loop 120 is configured in the various embodiments with means for clearance of a tool to axially rotate the shank 110. These configurations, explained in greater detail below, allow the insertion and driving of threaded hooks and eye bolts with a power tool. They also facilitate the alignment of the driving tool and threaded fastener 100 normal to the attachment surface. In selected embodiments, the threaded portion of the fastener 100 is stabilized by the driving tool. In such an embodiment, the bore 135 in the loop 120 extends around and maintains alignment of the driving tool working end parallel to the bore 130 walls and the central axis 112 of the threaded shank 110.

In the case of simple linear drive tool, such a screw drivers and electric screw drivers, a conventional hook or loop would preclude the drive shaft of the tool from reaching the tool receiving portion 130 and also being aligned with the axis 112 of the shank 110, as the shank axis 112 and tool axis need to be co-linear for rotating the shank about its axis.

In the various embodiment of the instant invention this is overcome in two alternative methods in which the hook or loop 120 either is offset sideways to allow driver access, or has a bore 135 to receive the driver.

The outward loop 120 extends at least below the lower vertical extent (reference line 114 in FIG. 1C) of the shank 110 as it extends away from the shank 114. This provides a large loop 120 with significant support or holding capacity and strength.

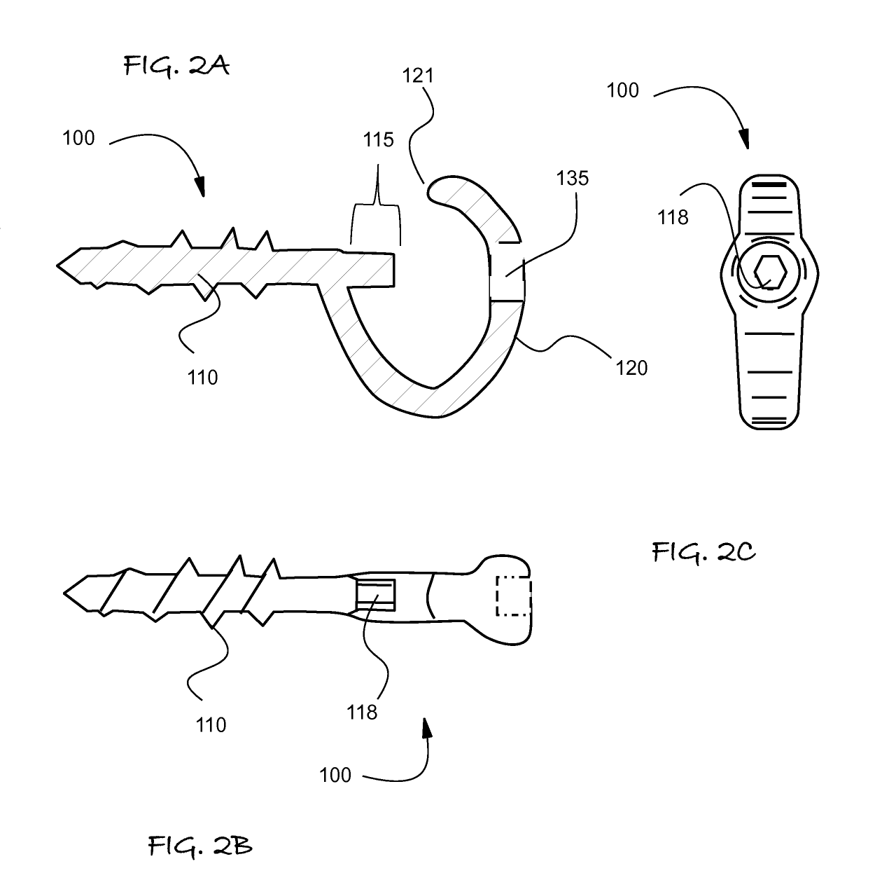

In an alternative embodiment of FIGS. 2, 5, 8, 9 and 11, the loop 120 is connected to the shank 110 between the first end 111a and the second end 111b, to leave an extending portion 115 beyond the first connection of the loop 120. Thus, portion 115 extends toward an opposing end of the loop 120.

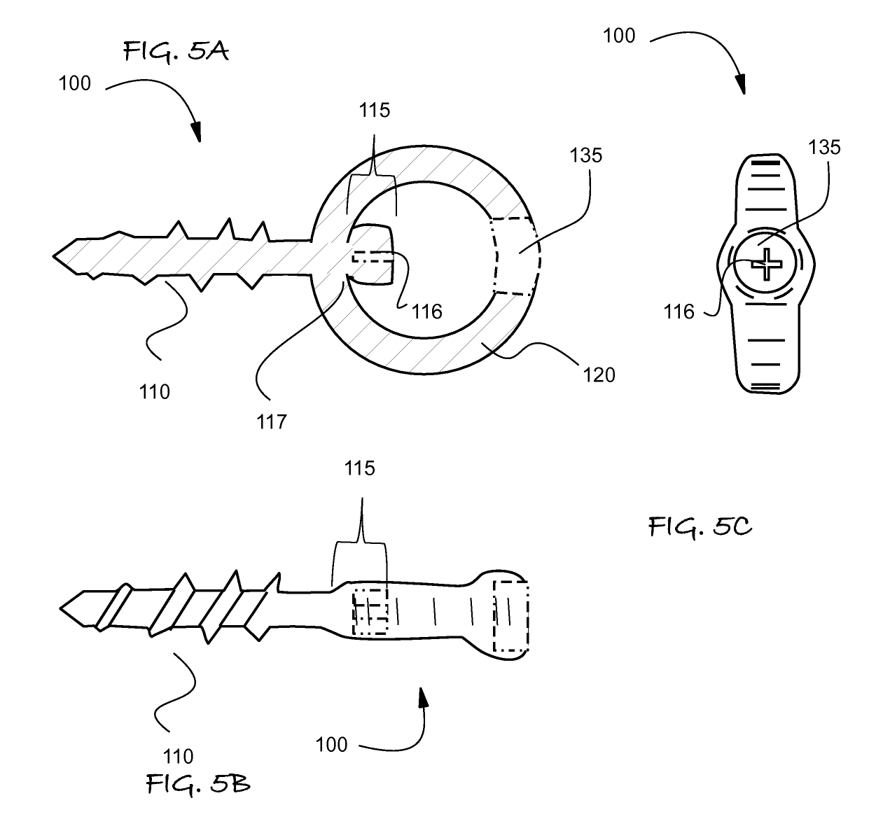

In some embodiments (FIGS. 5, 7 and 9A-C) the extending portion 115 of the shank 110 has a polygonal opening 116 and the depth of the polygonal opening 116 extends no further than the connection 117 of the loop 120 to the shank 110. Alternatively, as shown in FIG. 2 the extending portion 115 can have a bolt head 118 for receiving a driving tool. Limiting the initiation of the loop 120 until beyond the opening 116 avoids the loss of material to the opening or recess 130 from weakening the strength of the loop 120, or provides a stronger loop 120 for the amount of material used. In other words, an opening placed within the path between the shank 110 and the loop 120 reduces the cross-section of the stress bearing portion of the fastener 100 when an object is supported by the loop 120.

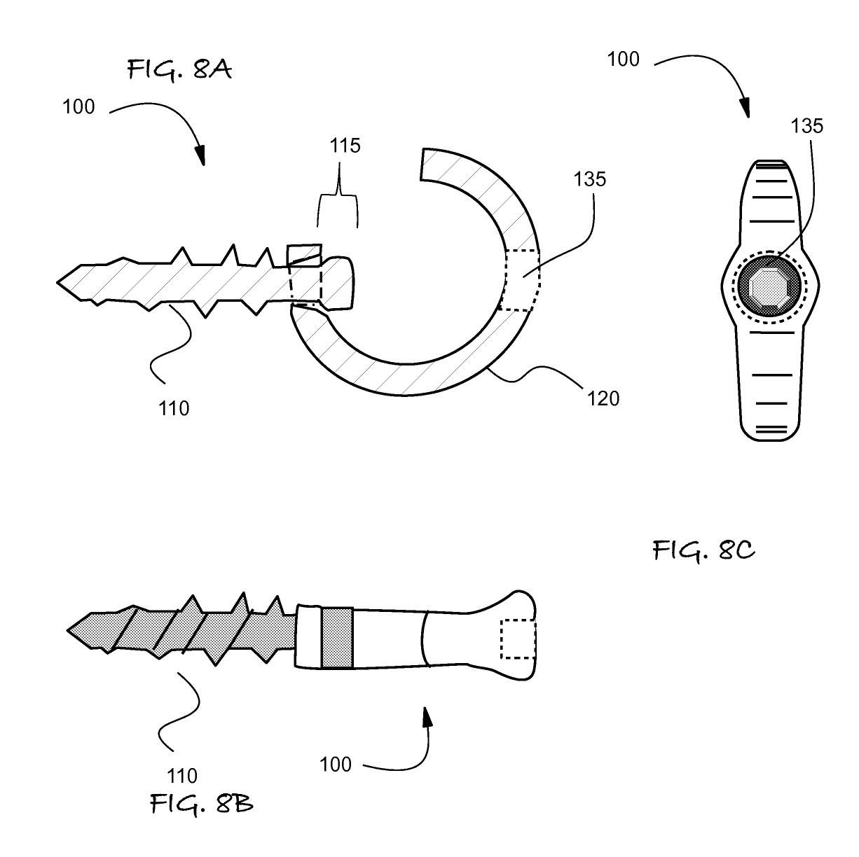

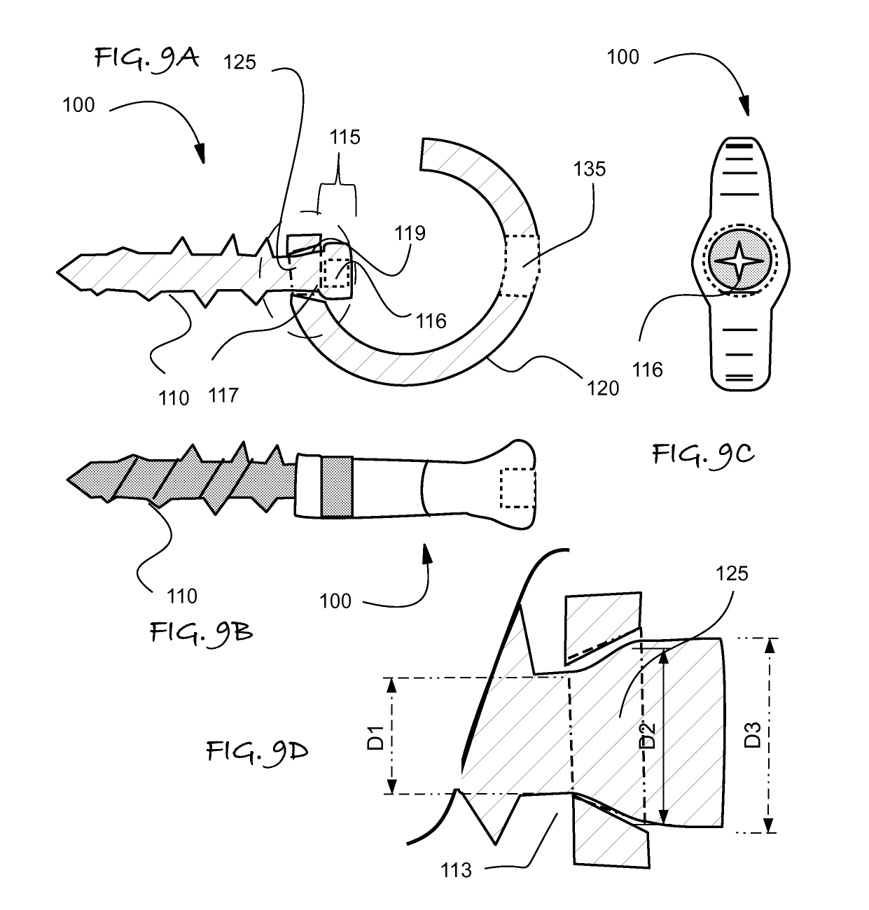

As shown in the embodiment of FIGS. 8A-C, 9A-D and 12, and more particularly the expanded portion of the FIG. 9A in FIG. 9D, the loop 120 and shank 110 are optionally separable. In these embodiments, threaded shank 110 has an annular recess 113 proximal to the second end 111b with the recess 113 having a first diameter D1, and the portions of the shank 110 adjacent the annular recess 113 each having a third diameter D3 that is larger than the first diameter. The loop 120 has a channel 125 with a second diameter D2 greater than the first diameter and less than the third diameter. Hence, the annular recess 113 of the shank 110 is retained within the channel 125.

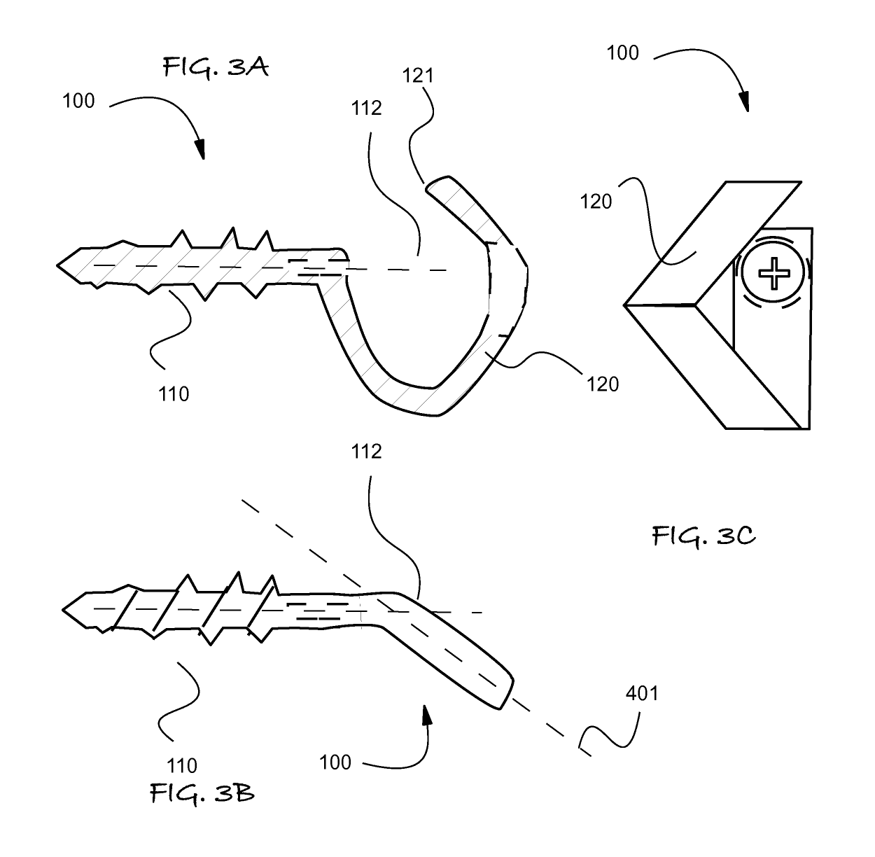

A means for clearing the axial extension of the shank 110 is the bore 135 in the loop 120 that is disposed at the intersection of an outward extension from the primary axis 112. In the embodiments in which the shank 110 and loop 120 are separable, the channel 125 and bore 130 would co-align to a common cylindrical axis 112 with the shank 110. An alternative means for clearing the axial extension of the shank 110 is shown in FIGS. 3A-C and 4A-C, in which the fastener 110 deploys an oblique angular displacement of the portion of the loop 120 that is opposite the axial extension of the shank 110 toward the distal portion of the loop 120. The angular displacement can be defined with respect to a reference plane 401 containing the outward portion of the loop 112 which is at an oblique angle with respect to the shank axis 112.

In order to maintain maximum strength of the loop 120, in the more preferred embodiment the portion of the loop 120 having the bore 135 bulges outward to maintain the same cross-section area as the portions of the loop 120 between the bore 135 and the shank 110

In FIG. 3A-C, the loop 120 is open at the top, but avoids interfering with the driver hole by extending laterally after reaching a low point, and then on rising extends laterally in the opposing direction before rising above tool end 130. Hence, loop 120 is composed of 3 attached segments 120a, 120b and 120c, which terminates in end 121.

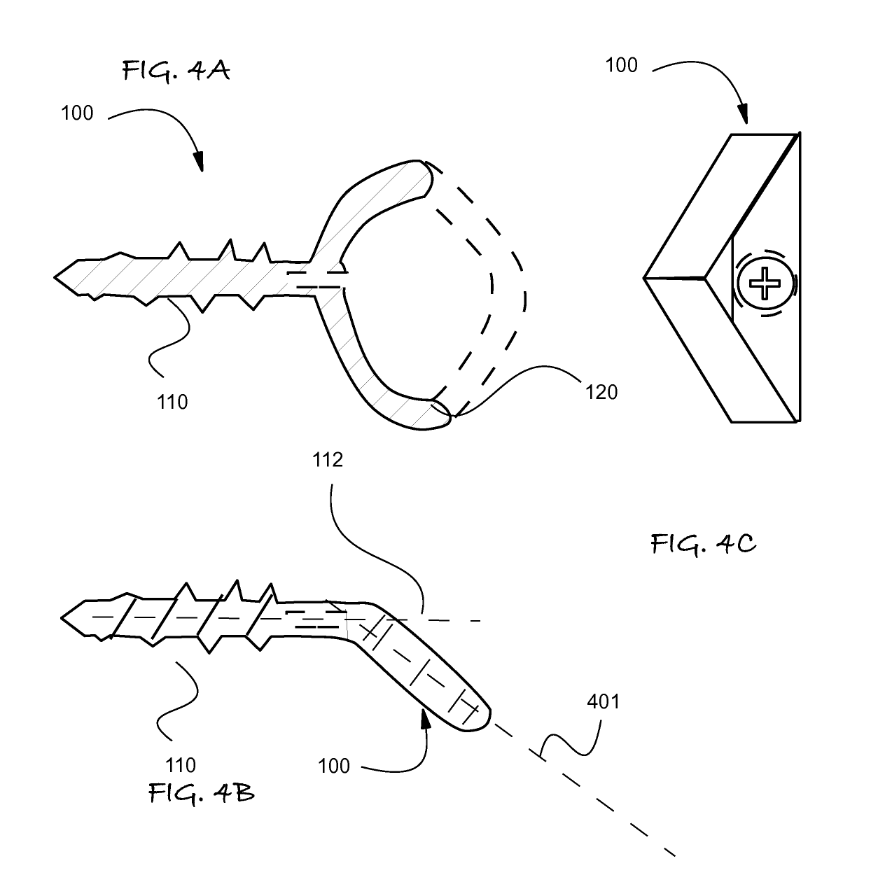

In FIG. 4A-C, the loop 120 is closed, but avoids interfering with the driver hole 130 by extending laterally after reaching a low point, and then rising as it extends laterally in the opposing direction until above shank end 111b, but the extends downward to connect just forward of shank end 111b.

The loop 120 is optionally open or closed, as shown in FIGS. 4A-C, 5A-C and 6A-C. It should be appreciated that to form a hook of reasonable proportion to support or hold items, the open loop 120 preferably extends above the shank 110 after extending below it.

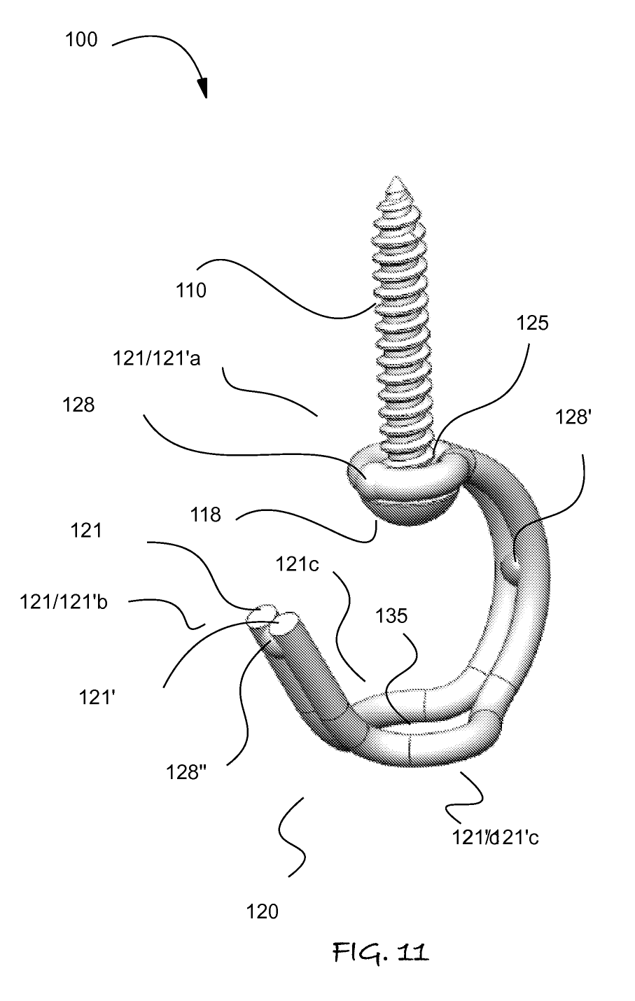

In the embodiment of FIG. 11 the fastener is fabricated from one or more elongated members with circular cross-sections are bent or forged to form mirror image mating pairs 121 and 121′ of split hook shaped preform that are attached to the threaded shank 110 after forming. The portion of the loop 120 having the bore 135 is defined by convex outward bow 121/121′c of each mating pair 121 and 121′ between the proximal 121/121′a and distal ends 121/121b. The portion of the each elongated member adjacent proximal ends 121/121′a are bent to a semi-circular shape for attachment to the shank 111 just below the bolt head 118, where they are preferably joined thereto by at least one weld 128. Additional welds 128′ and 128″ join the mating halves 121 and 121′ at the distal ends 121/121′b and between the proximal end 121/121′a and the bore 135 defined by the gap between arced segment 121c and 121′c. The shank head 118 having the Philips style receiving driver slot extends beyond the proximal end connection of the completed loop 120 to the shank 110 circa weld 128.

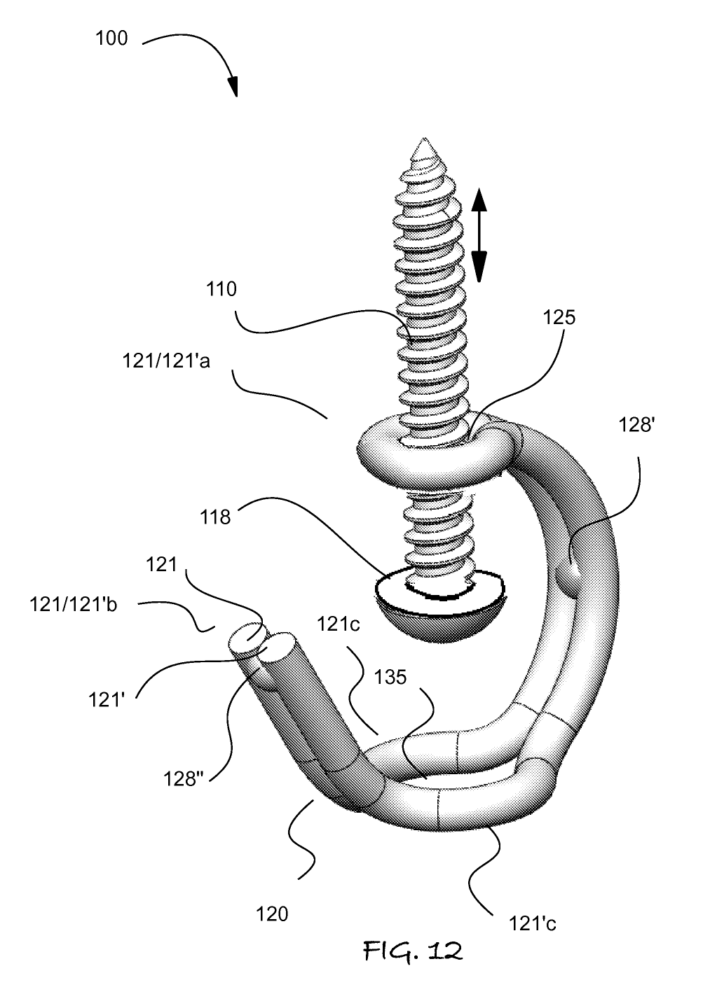

FIG. 12 is a perspective view of another embodiment of the invention in which the fastener 100 loop is similarly fabricated to the embodiment of FIG. 11, that is from one or more elongated members, which preferably have a circular cross-sections. Fastener 100 in FIG. 12 then receives a screw 110 in the eyelet or channel 125. However, when 2 preforms are used they need not be welded to the screw or shank below the head 118, but rather welded to each other at 128″ to form an eyelet 125 below the shank head 118. The eyelet 125 can also be formed by bending a single wire or deformable elongated member around the shank 110, with the portions on opposing sides of the bend then being deformed to form mirror image half 121/121′ as in FIG. 11, which are similar joined by welds 128′ and 128″.

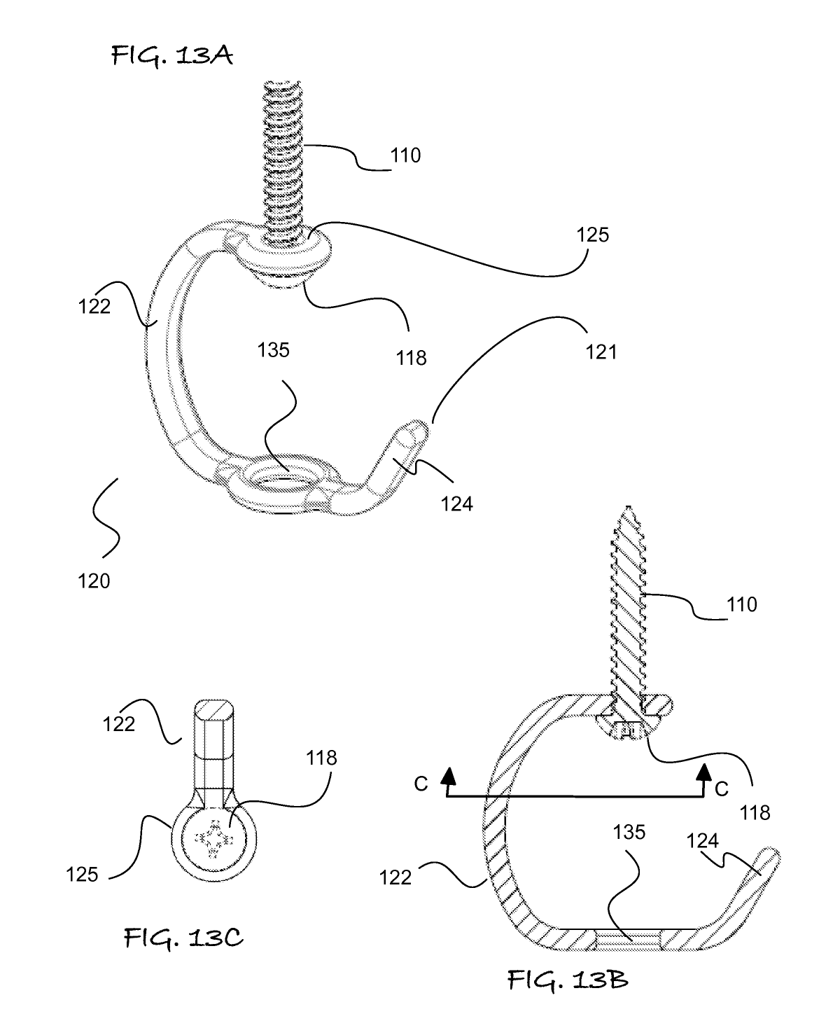

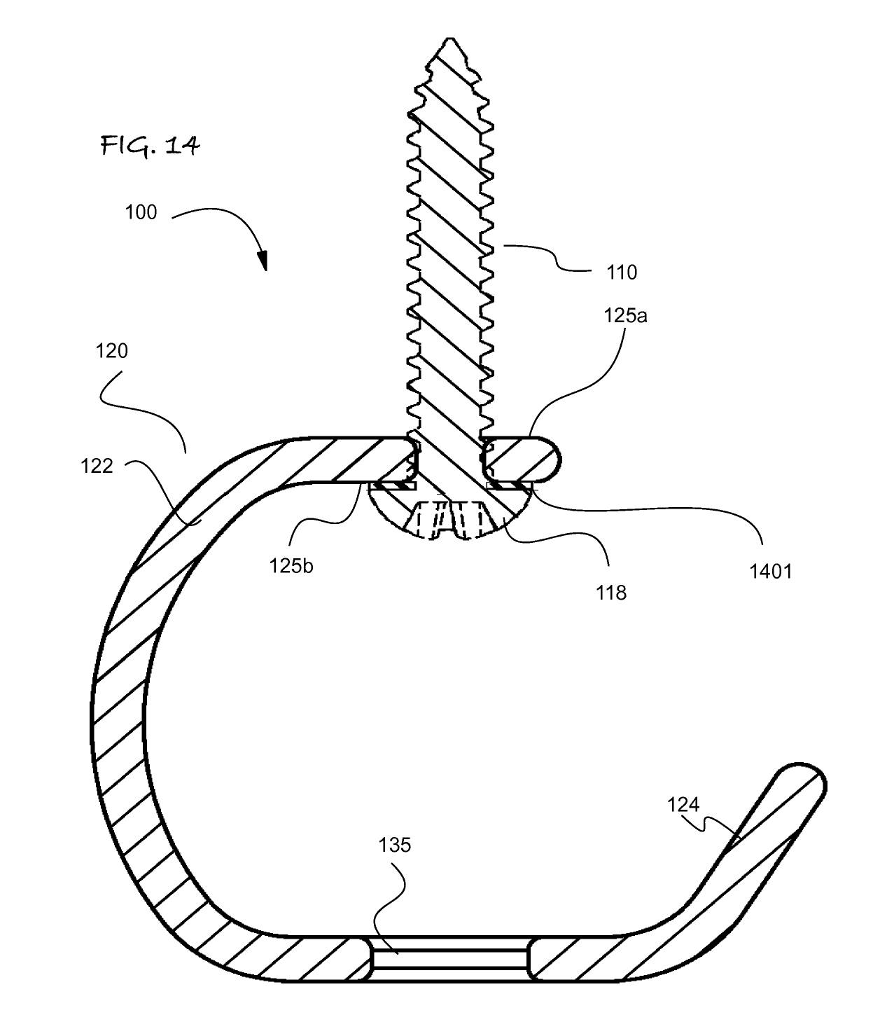

In the embodiment of FIG. 13A-C the fastener 100 has the same general shape as the embodiments of FIGS. 11 and 12, but is formed by molding or casting. The screw 110 is separate and hence can be removed from the eyelet or channel 125. More preferably, as shown in FIG. 14, the screw 110 is attached directly or proximal the eyelet or bore 125, such as at lower edge 125b, with a weak adhesive material 1401 so it does not fall out during initially placement during use. When the fastener 100 is initially attached with a power tool the entire fastener 100 will first spin as the screw 110 is rotated by the power tool driver. However, when the upward facing eyelet edge 125a reaches and is then further urged against the wall or ceiling surface the screw 110 will then break free of this temporary adhesive 1401 and continue to rotate but the loop portion 120 will cease to rotate. This permits the full tightening of the screw 110 in the wall or ceiling, but the angular or rotation orientation of the loop 120 can still be adjusted to a final position by hand before fully inserting the screw 110. The adhesive is optionally a water or solvent based organic polymer type adhesive such a Locktite® brand resins, or is a hot melt adhesive. The adhesive 1401 need not be placed around the entire periphery of the screw head, the eyelet 125 or a particular eyelet surface, such as 125a or 125b. It should be apparent that stronger adhesives can be deployed when it is desired to continuously rotate the screw 110 and loop 120 together. The assembly with an adhesive simplified fabrication by allowing different manufacturing methods for each component, and the mixing of different screws depending on the nature of the wall or ceiling surface the device 100 is to be attached to.

The loop in this embodiment (FIG. 13A-C and FIG. 14) the loop 120 has several portions, with a flat portion at bore 135 and eyelet or channel opening 125, and curved and optional some flat portion there between. Preferably loop 120 has a curvilinear loop portion 122 that extends between eyelet 125 for receiving the threaded shank 111 and the planar ring structure that defines the bore 135 for receiving the driver of the bolt or shank head 118. The portions of the loop 120 adjacent to bore 135 and on opposing sides thereof are co-planar with the planar ring structure that defines the bore 135 or second eyelet. In this preferred embodiment a linear segment 124 extends from the planar ring structure about bore 135 to the end of the hook 121.

It should be appreciated from these embodiment that the loop 120 can have multiple segments of which some or all are at least part curvilinear in shape or polygonal shaped. For example, in FIG. 3A-C and FIG. 4A-C, portion of the loop 1120 are curvilinear proximal to the connected shank end 111b, while the portion opposite the shank axis 112 have a polygonal shape.

It should also be appreciated from the various embodiments described above and illustrated herein that the second end 111b of the shank 110 can have a recess 130 to accept any type driver end fitting, such as a Philips head drivers, a “TORX”® drivers, square driver or a hexagonal driver, as well as an external bolt head in place of the recess 130. The bolt head can also be combined with a driver receiving recess 130. Hence the head of the threaded shank or shaft can have various means for receiving rotary driving tools.

It should be understood that the inclusion of various optional features and aspects of the invention in one embodiment does not preclude their use in other and additional embodiments of the invention. Hence, while the invention has been described in connection with various preferred embodiments, it is not intended to limit the scope of the invention to the particular form set forth, but on the contrary, it is intended to cover such alternatives, modifications, and equivalents as may be within the spirit and scope of the invention as defined by the appended claims.

What is claimed is:

1. A fastener comprising:
an eyelet loop, forming a loop shaped section,
said eyelet loop having a first hole at a first section, said first hole holding a threaded fastener therein, where said fastener has a fastener head that holds against an inside surface of the first hole,
an outside surface of the first hole adapted and sized for abutting against an attachment surface to which the eyelet loop will be fastened,
said eyelet loop having a second hole on an opposite section of the loop from a location of the first hole,
where an axis extends between said first hole and said second hole, and said axis being perpendicular to the attachment surface,
where said second hole is defined by inner surfaces that allow for clearance of a driving tool to be inserted on and along said axis and perpendicular to said attachment surface, and where the driving tool has a connection to the head of the fastener that rotates said fastener, and where said surfaces are sized to allow the tool to be inserted through the second hole along the axis to the first hole to rotate the fastener as the tool is rotated, and
where the threaded fastener is also on the axis extending between the first hole and the second hole,
where the head of the threaded fastener holds against the inside surface of the first hole and does not fall out of the first hole without unscrewing.

2. The fastener as in claim 1, further comprising the driving tool, having a diameter that causes the driving tool in the second hole to maintain alignment of the driving tool in the threaded fastener normal to the attachment surface.

3. The fastener as in claim 2, wherein the second hole has walls that interact with the driving tool to maintain the alignment of the driving tool on the axis and perpendicular to the attachment surface.

4. The fastener according to claim 1 wherein a portion of the loop with the second hole formed therein bulges outward at its edges around the second hole, to maintain a same cross sectional area of an area of the loop around the second hole, as in other areas of the loop.

5. The fastener as in claim 1, wherein the loop is open at its top.

6. The fastener as in claim 1, wherein the loop is in the shape of at least a section of a sphere.

7. The fastener as in claim 1, wherein the loop is in the shape of a first portion that extends down from the first hole, a second portion that extends up, and a third portion that extends up from the second portion back towards the first hole, wherein the second hole is formed between the second portion and the third portion.

8. The fastener as in claim 7, wherein the loop, the first portion, the second portion and the third portion are formed of separate segments.

9. The fastener as in claim 1, wherein the fastener is fabricated from an elongated member having a circular cross section.

10. The fastener as in claim 1, wherein there are two sections of the eyelet loop, and the first and second holes are formed between the two sections.

11. The fastener as in claim 1, wherein the fastener is formed as a molded piece.

12. The fastener as in claim 1, wherein the loop has a first flat portion adapted for abutting against the attachment surface, a second flat portion opposite to the first flat portion, and holding the second hole through which the driving tool is inserted, and at least one curved portion extending between the first flat portion and the second flat portion.

13. The fastener as in claim 1, wherein the threaded fastener has a shank of a second diameter, and screw threads which extend from the shank to form a screw thread diameter larger than the second diameter and where the screw threads are larger in diameter than the second hole to hold the threaded fastener into the second hole without being removable from the second hole without unscrewing.

14. A method of driving a fastener comprising:
attaching an eyelet loop, formed of a loop shaped section, to an attachment surface,
said eyelet loop having a first hole at a first section,
surfaces of said first hole holding a threaded fastener therein, where said fastener has a fastener head that holds against an inside surface of the first hole,
an outside surface of the first hole adapted and sized for abutting against the attachment surface to which the eyelet loop will be fastened,
said eyelet loop having a second hole on an opposite section of the loop from a location of the first hole,
where an axis extends between said first hole and said second hole, and said axis being perpendicular to the attachment surface,
inserting a driving tool into said second hole such that inner surfaces of said second hole allow for clearance of a driving tool to be inserted on and along said axis and perpendicular to said attachment surface,
and where the driving tool has a connection to the head of the fastener that rotates said fastener, and where said surfaces are sized to allow the tool to be inserted through the second hole along the axis to the first hole to rotate the fastener as the tool is rotated, and rotating the tool to insert the fastener into the attachment surface;
where the threaded fastener is also on the axis extending between the first hole and the second hole,
where the head of the threaded fastener holds against the inside surface of the first hole and does not fall out of the first hole without unscrewing.

15. The method as in claim 14, wherein the surfaces of the driving tool align on surfaces of the second hole to align the driving tool on the axis.
